(19) United States
(12) Patent Application Publication
(10) Pub. No.: US 2012/0055772 A1
(43) Pub. Date: Mar. 8, 2012

(54) KEYBOARD FO REDUCING ASSEMBLY PROCEDURES

(76) Inventor: Chin-Yi LIN, Taipei Hsien (TW)

(21) Appl. No.: 12/876,770

(22) Filed: Sep. 7, 2010

(51) Int. Cl. H01H 13/7065; H01H 13/70

(52) U.S. Cl. 200/344

(57) ABSTRACT

A keyboard for reducing assembly procedures mainly includes a baseboard, a driven mechanism and a holding board located on the baseboard. The baseboard has at least two horizontal detent portions forming a holding space therebetween. The driven mechanism has a coupling member and an elastic member. The coupling member has a retaining portion at one side held in the holding space and a keycap at another side supported by the elastic element. The holding board is located between the baseboard and keycap, and has an opening corresponding to the driven mechanism and a vertical detent portion to cover the holding space to confine the driven mechanism. Thus the horizontal detent portions and vertical detent portion can confine the horizontal and vertical movements of the driven mechanism to form anchoring. Assembly processes of the driven mechanism are simplified and total assembly time is shortened to facilitate automatic production and improve productivity.

### FIELD OF THE INVENTION

The present invention relates to a keyboard for reducing assembly procedures and particularly to a keyboard for computers whose assembly procedures can be simplified.

### BACKGROUND OF THE INVENTION

With constant advance of technology and fast development of information products, computers are widely used in people's daily life. Nowadays most businesses have to rely on the computers which become indispensable. When a computer is in use, an input device has to be provided as a human machine interface to enter commands to make the computer to execute specific tasks. Keyboard is the most commonly used input device.

A conventional keyboard can be seen in U.S. Pat. Nos. 7,154,059 and 6,554,442, mainly includes a baseboard, a circuit board located on the baseboard and a plurality of keycaps located on the baseboard. The baseboard has a bridge mechanism connected with each of the keycaps, and the keycap and the circuit board are interposed by an elastic element. When the keycap is depressed by a user, the bridge mechanism is driven to move downwards to compress the elastic element to trigger the circuit board to output a signal. When the keycap is released, the elastic element provides an elastic force to push the keycap and bridge mechanism upwards so that the keycap returns to its original position ready for next depression.

U.S. Pat. Nos. 7,154,059 and 6,554,442 mentioned above have a bridge mechanism and baseboard assembled as shown in FIG. 1. They mainly include a baseboard 100 with a coupling portion 110 located thereon to connect with a bridge mechanism 200. The coupling portion 100 includes a horizontal detent portion 111 extended upwards and a vertical detent portion 112 extended from the horizontal detent portion 111. When a keycap 300 is depressed, the bridge mechanism 200 also is moved up and down. The horizontal detent portion 111 constrains the horizontal displacement of the bridge mechanism 200 while the vertical detent portion 112 restricts the vertical displacement of the bridge mechanism 200 so that the bridge mechanism 200 is securely held on the baseboard 100 without loosening off. During fabrication of the horizontal detent portion 111 and vertical detent portion 112, structural strength thereof has to be taken into account to avoid damage caused by a great depressing force of the keycap 300 that would make replacement of the entire keyboard necessarily. Moreover, the length of the vertical detent portion 112 has also to be taken into account to cover the total horizontal displacement of the bridge mechanism 200 to prevent the bridge mechanism 200 from moving out of the length of the vertical detent portion 112 and result in escaping from the elastic element and cause uselessness of the keyboard.

During assembly of the bridge mechanism of the aforesaid conventional keyboard, a vertical depressing force is applied first, then a horizontal push force is applied to install the bridge mechanism on the baseboard. As there are a great number of keys on the keyboard, and the bridge mechanism of each key has to go through two steps as previously discussed to finish installation, assembly process of the bridge mechanism is tedious. Moreover, the anchor portion of the bridge mechanism and baseboard is formed at a small size, assembly is difficult and a great care is needed. A slight negligence could damage the bridge mechanism, hence more assembly time is required.

### SUMMARY OF THE INVENTION

The primary object of the present invention is to solve the aforesaid disadvantage by simplifying assembly structure for keycaps and a baseboard to reduce assembly time of a keyboard.

To achieve the foregoing object, the present invention provides a keyboard for reducing assembly procedures that includes a baseboard, a driven mechanism located on the baseboard and a holding board located on the baseboard. The baseboard has at least two horizontal detent portions to form a holding space between them. The driven mechanism has a coupling member and an elastic member located on the baseboard. The coupling member has a retaining portion at one side held in the holding space and another side coupled with a keycap. The elastic member supports the keycap. The holding board is interposed between the baseboard and the keycap, and has an opening corresponding to the driven mechanism and a vertical detent portion to cover the holding space to anchor the driven mechanism. Hence when the keycap is depressed, the coupling member is driven to move horizontally and vertically, the horizontal detent portion on the baseboard and vertical detent portion on the holding board can respectively confine the horizontal and vertical movements of the coupling member for secure positioning.

Therefore, the driven mechanism can be disposed in the holding space from the upper side to the lower side and quickly installed on the baseboard. All the elements of the keyboard are overlapped in an up and down manner, and can be assembled without complicated processes. In addition to simplifying assembly of the driven mechanism, total assembly time also can be reduced to facilitate automatic production and improve productivity.

The foregoing, as well as additional objects, features and advantages of the invention will be more readily apparent from the following detailed description, which proceeds with reference to the accompanying embodiment and drawings. The embodiment serves merely for illustrative purpose and is not the limitation of the invention.

### BRIEF DESCRIPTION OF THE DRAWINGS

FIG. 1 is a schematic view of the structure of a conventional keyboard.

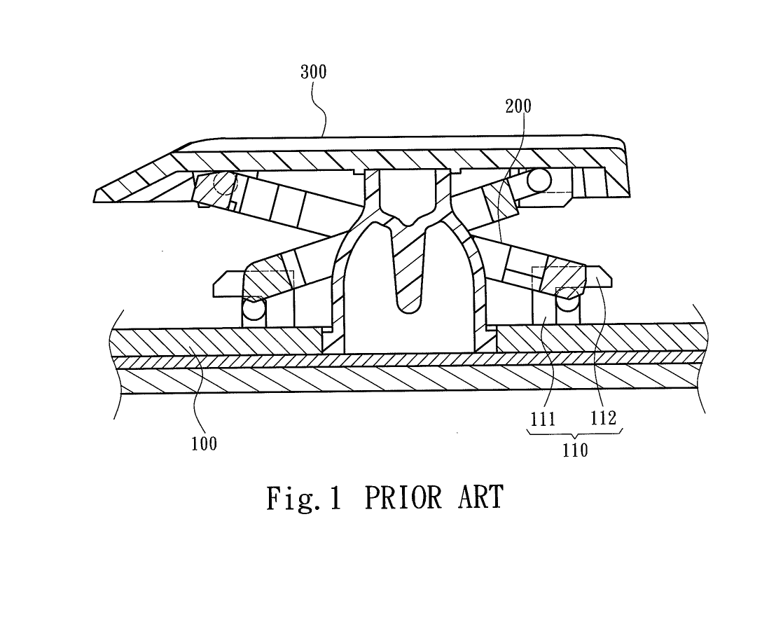

FIG. 2 is an exploded view of the structure of the invention.

FIG. 3 is another exploded view of the structure of the invention.

FIG. 4 is yet another exploded view of the structure of the invention.

FIG. 5 is a sectional view of the invention.

### DETAILED DESCRIPTION OF THE PREFERRED EMBODIMENT

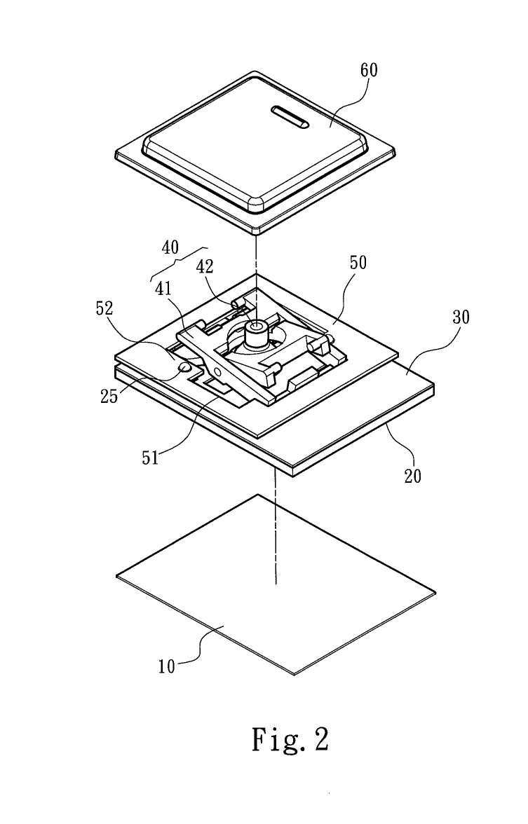

Please refer to FIG. 2, the present invention aims to provide a keyboard for reducing assembly procedures which mainly includes a bottom board 10, a baseboard 20 located on the bottom board 10, a circuit board 30 located on the baseboard 20, a driven mechanism 40, a holding board 50 and a keycap 60.

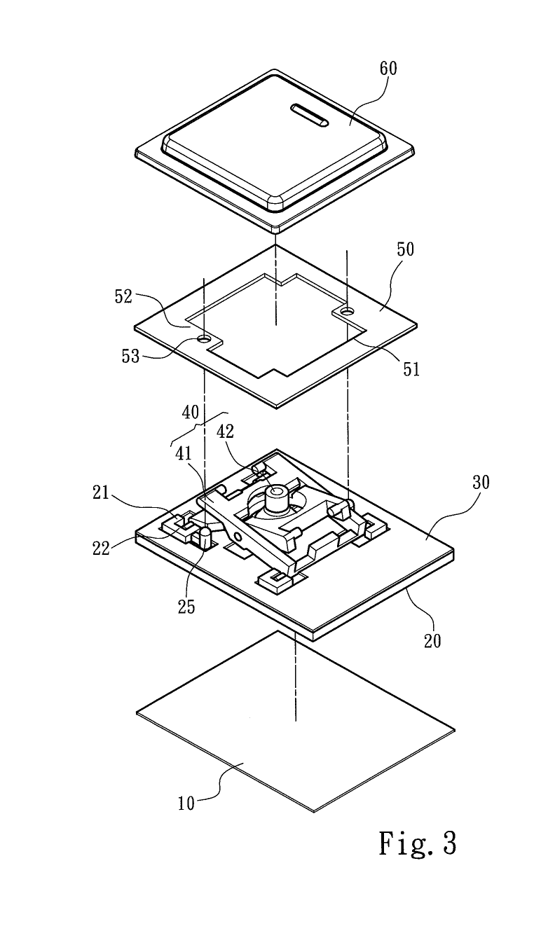

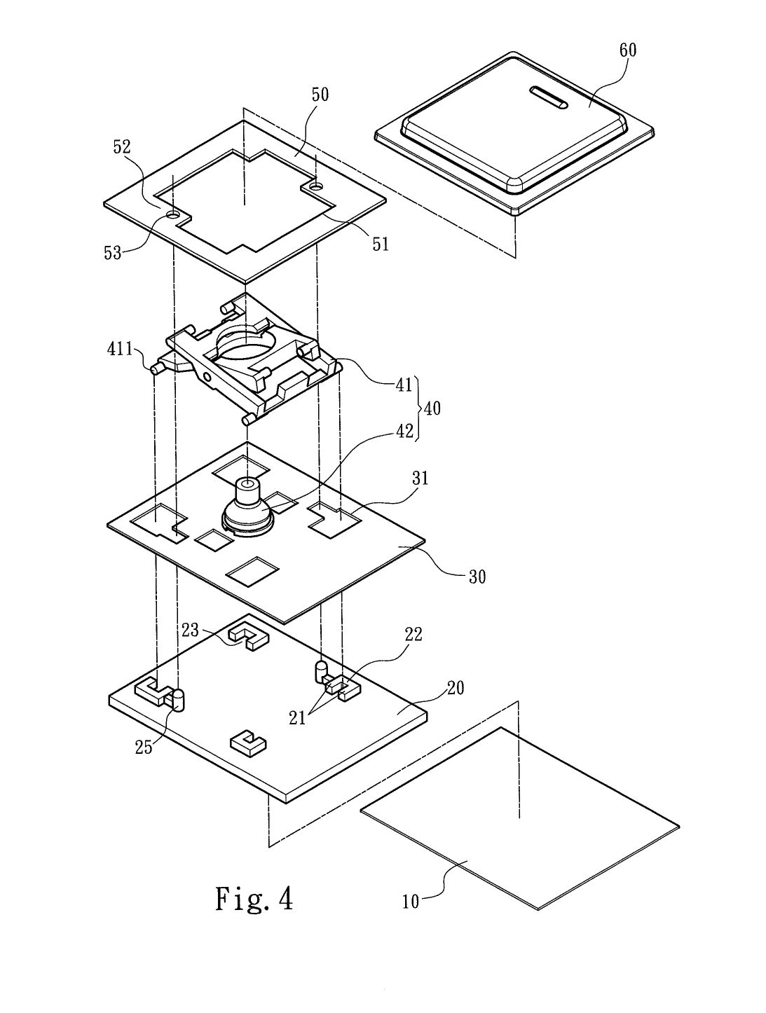

Also referring to FIGS. 3 and 4, the baseboard 20 has at least two horizontal detent portions 21 bridged by a detent wall 22 to form a U shape with a holding space 23 formed between the two horizontal detent portions 21. The driven mechanism 40 includes a coupling member 41 and an elastic member 42 located on the baseboard 20. The coupling member 41 has a retaining portion 411 at one side to be held in the holding space 23 and confined by the two horizontal detent portions 21 and detent wall 22, and another side coupled with the keycap 60. The keycap 60 is supported by the elastic member 42. The circuit board 30 is interposed between the driven mechanism 40 and baseboard 20, and has a through hole 31 run through by the horizontal detent portion 21. The keycap 60 is depressible to compress and trigger the elastic member 42 to output a signal. The holding board 50 is located between the baseboard 20 and the keycap 60, and has an opening 51 corresponding to the driven mechanism 40 and a vertical detent portion 52 to cover the holding space 23 to anchor the driven mechanism 40. Thus forms the main structure of the invention.

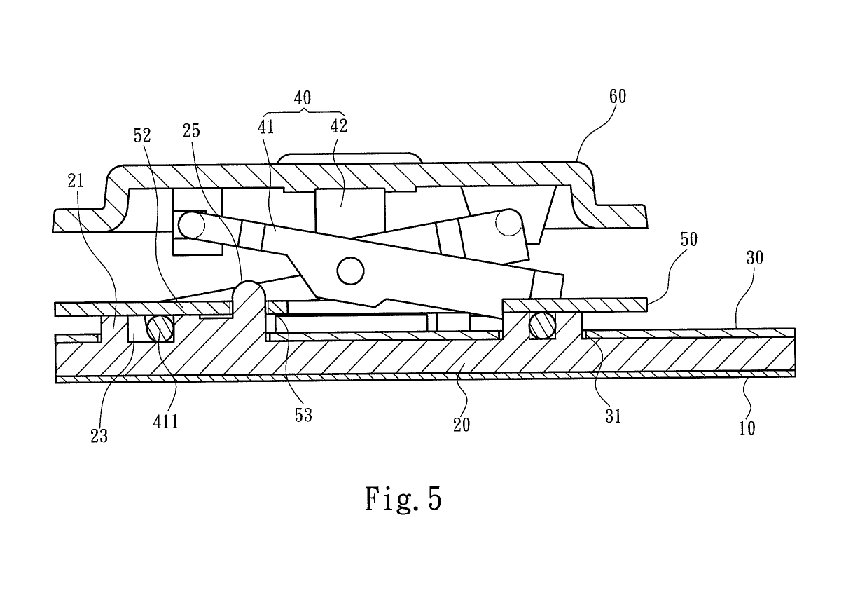

In one embodiment of the invention, the holding board 50 and baseboard 20 have respectively a first anchor portion 53 and a second anchor portion 25 to form positioning. As shown in the drawings, the first anchor portion 53 and second anchor portion 25 are an aperture and a strut mating each other so that they can be coupled together for positioning. They also may be anchored together by thermal fusion after being coupled. Referring to FIG. 5, for assembly, first, place the baseboard 20 onto the bottom board 10; align the through hole 31 of the circuit board 30 to the horizontal detent portion 21 of the baseboard 20 to place the circuit board 30 onto the baseboard 20; wedge the retaining portion 411 of the driven mechanism 40 in the holding space 23 formed between the two horizontal detent portions 21; align the opening 51 of the holding board 50 to the driven mechanism 40, and cover the vertical detent portion 52 of the holding board 50 over the holding space 23; finally install the keycap 60 onto the driven mechanism 40. Thus all the elements are overlapped in this order from the lower side to the upper side to become a finished keyboard product without complicated assembly processes.

As a conclusion, the invention mainly provides at least two horizontal detent portions 21 on the baseboard 20 to form a holding space 23 between them, and a vertical detent portion 52 to cover the holding space 23. Thus the horizontal detent portions 21 and vertical detent portion 52 not only can confine the horizontal and vertical movements of the coupling member 41 while the keycap 60 is depressed, assembly processes of the driven mechanism 40 also is simplified. All the elements of the keyboard can be assembled by overlapping in an up and down manner. Total assembly time is shortened and automatic production can be implemented easier to improve productivity.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A keyboard for reducing assembly procedures, comprising:
a baseboard including at least two horizontal detent portions formed a holding space therebetween;
a driven mechanism including a coupling member and an elastic member located on the baseboard, the coupling member including a retaining portion at one side held in the holding space and a keycap at another side supported by the elastic member; and
a holding board which is located between the baseboard and the keycap including an opening corresponding to the driven mechanism and a vertical detent portion to cover the holding space to anchor the driven mechanism.

2. The keyboard of claim 1 further including a detent wall to bridge the two horizontal detent portions to form a U shape therewith.

3. The keyboard of claim 2, wherein the detent wall is perpendicular to the two horizontal detent portions.

4. The keyboard of claim 1, wherein the holding board and the baseboard include respectively a first anchor portion and a second anchor portion to form positioning.

5. The keyboard of claim 4, wherein the first anchor portion and the second anchor portion are an aperture and a strut mating each other for coupling.

6. The keyboard of claim 1, wherein the driven mechanism and the baseboard are interposed by a circuit board.

7. The keyboard of claim 6, wherein the circuit board includes an aperture run through by the horizontal detent portion.

8. The keyboard of claim 1 further including a bottom board to hold the baseboard.
